(19) United States
(12) Patent Application Publication
(10) Pub. No.: US 2024/0248574 A1
(43) Pub. Date: Jul. 25, 2024

(54) Systems and Methods for Presenting an Inline Frame Modal in the Parent Window

(71) Applicant: Contentstack Inc., San Francisco, CA (US)

(72) Inventors: Nikhil Vasant Jain, Mumbai (IN); Hitesh Bhaskar Shetty, Mira Bhayandar (IN)

(21) Appl. No.: 18/365,782

(22) Filed: Aug. 4, 2023

(30) Foreign Application Priority Data
Jan. 24, 2023 (IN) 202321004603

(51) Int. Cl. G06F 3/0481; G06F 3/04845

(52) U.S. Cl. CPC G06F 3/0481; G06F 3/04845; G06F 2203/04804

(57) ABSTRACT

Example embodiments of the present disclosure provide for an example method for presenting an inline frame (iFrame) modal in the parent window. The example method includes providing for display a parent window comprising a plurality of selectable user interface elements. User input can be obtained and the first iFrame can be resized to be larger than the original size. The opacity of the first iFrame can be reduced and a second iFrame can be generated. The second iFrame can be an imitation DOM that is a duplicate of the first iFrame. The second iFrame can be displayed such that it is the same as the original size of the first iFrame. The example method includes opening a modal window associated with the modal component within the resized first iFrame such that the modal window appears to be opened within the parent window and outside the first iFrame.

### PRIORITY CLAIM

The present application is based on and claims priority to Indian Provisional patent application Ser. No. 202321004603, having a filing date of Jan. 24, 2023, which is incorporated by reference herein.

### FIELD

The present disclosure relates generally to systems and methods for presenting an inline frame (iFrame) modal in the parent window.

### BACKGROUND

Computing devices can present windows including interactive elements such as iFrames and modals.

### SUMMARY

Aspects and advantages of embodiments of the present disclosure will be set forth in part in the following description, or can be learned from the description, or can be learned through practice of the embodiments.

In one example aspect, the present disclosure provides for an example computer-implemented method. The example computer-implemented method includes providing for display via a user interface of a client device an interface comprising a parent window comprising a plurality of selectable user interface elements. The plurality of selectable user interface elements comprises at least a first iFrame including a modal component. The first iFrame has a first size constraint. The example computer-implemented method includes obtaining data indicative of a user input comprising selection of an interactive modal element of a user interface. The example computer-implemented method includes in response to obtaining data indicative of the user input, resizing the first iFrame to a size larger than the first size constraint. The example computer-implemented method includes decreasing an opacity of the first iFrame. The example computer-implemented method includes generating a second iFrame. The second iFrame is an imitation DOM that is a duplicate of the first iFrame. The example computer-implemented method includes presenting the second iFrame at a location within the parent window that is the same as the first size constraint of the first iFrame. The example computer-implemented method includes opening a modal window associated with the modal component within the resized first iFrame, wherein the modal window appears to be opened within the parent window and outside the first iFrame.

In an example aspect, the present disclosure provides for an example system for presenting an inline frame modal in the parent window, including one or more processors and one or more memory devices storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include providing for display via a user interface of a client device an interface comprising a parent window comprising a plurality of selectable user interface elements. The plurality of selectable user interface elements comprises at least a first iFrame including a modal component. The first iFrame has a first size constraint. In the example system, the operations can include obtaining data indicative of a user input comprising selection of an interactive modal element of a user interface. In the example system, the operations can include in response to obtaining data indicative of the user input, resizing the first iFrame to a size larger than the first size constraint. In the example system, the operations can include decreasing an opacity of the first iFrame. In the example system, the operations can include generating a second iFrame. The second iFrame is an imitation DOM that is a duplicate of the first iFrame. In the example system, the operations can include presenting the second iFrame at a location within the parent window that is the same as the first size constraint of the first iFrame. In the example system, the operations can include opening a modal window associated with the modal component within the resized first iFrame, wherein the modal window appears to be opened within the parent window and outside the first iFrame.

In an example aspect, the present disclosure provides for an example transitory or non-transitory computer-readable medium embodied in a computer-readable storage device and storing instructions that, when executed by a processor, cause the processor to perform operations. In the example transitory or non-transitory computer-readable medium, the operations include providing for display via a user interface of a client device an interface comprising a parent window comprising a plurality of selectable user interface elements. The plurality of selectable user interface elements comprises at least a first iFrame including a modal component. The first iFrame has a first size constraint. In the example system, the operations can include obtaining data indicative of a user input comprising selection of an interactive modal element of a user interface. In the example system, the operations can include in response to obtaining data indicative of the user input, resizing the first iFrame to a size larger than the first size constraint. In the example system, the operations can include decreasing an opacity of the first iFrame. In the example system, the operations can include generating a second iFrame. The second iFrame is an imitation DOM that is a duplicate of the first iFrame. In the example system, the operations can include presenting the second iFrame at a location within the parent window that is the same as the first size constraint of the first iFrame. In the example system, the operations can include opening a modal window associated with the modal component within the resized first iFrame, wherein the modal window appears to be opened within the parent window and outside the first iFrame.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for presenting iFrame modal in the parent window according to example embodiments of the present disclosure.

FIG. 2 depicts a block diagram of an example system for presenting iFrame modal in the parent window according to example embodiments of the present disclosure.

FIG. 3A-3H depict example user interfaces according to example embodiments of the present disclosure.

FIG. 4A-FIG. 4H depict example user interfaces according to example embodiments of the present disclosure.

FIG. 5 depicts a flowchart of an example method according to example embodiments of the present disclosure.

FIG. 6 depicts a block diagram of an example system for presenting iFrame modal in the parent window according to example embodiments of the present disclosure.

### DETAILED DESCRIPTION

The present disclosure provides for systems and methods directed to presenting an iFrame modal in the parent window. The present disclosure can be utilized to increase the window size available for opening a modal within an iFrame while giving the appearance of the iFrame modal opening within the parent window.

By giving the appearance that the iFrame modal is opened within the parent window, larger modals with more functionality can be presented as if they are within the parent frame while maintaining the security of keeping the modal within the iFrame. This can be accomplished without interrupting the end user experience of interacting with a modal in an iFrame.

For instance, the present disclosure can include a computing system providing for display a user interface including a parent window, an iFrame, and a modal component within the iFrame. The user can provide input selecting the modal component. The computing system can obtain data indicative of a user interaction with a modal component of an iFrame. In response, the computing system can resize the iFrame to a larger size. The computing system can generate a second imitation iFrame that mimics the initial iFrame. The computing system can decrease the opacity of the resized iFrame to zero (e.g., to make it appear that the second iFrame is the first iFrame, and the resized iFrame does not exist). The computing system can open the modal window within the iFrame. The modal window can appear to be opened within the parent window and outside the initial iFrame.

The present disclosure can provide for technical effects and benefits. For instance, traditionally, the amount of space for opening a modal has been constrained to within an iFrame. By generating the imitation iFrame and resizing the initial iFrame, the appearance of opening a modal within a parent window (and outside the bounds of the initial iFrame) can be achieved. This prevents the display of a modal being constrained within an iFrame where critical portions of the modal could be cropped as to not be displayed via a user interface (e.g., not displaying the entire modal, not having an interactive portion of the modal visible due to cropping). Additionally, the present disclosure allows for iFrames with different domains from the parent window to display information (e.g., a modal) that appears to be outside of the iFrame (and increase the previously constrained display area) while maintaining the security benefits of using an iFrame to prevent the iFrame content from unnecessary access to the content of the parent window.

With reference now to the Figures, example embodiments of the present disclosure will be discussed in further detail.

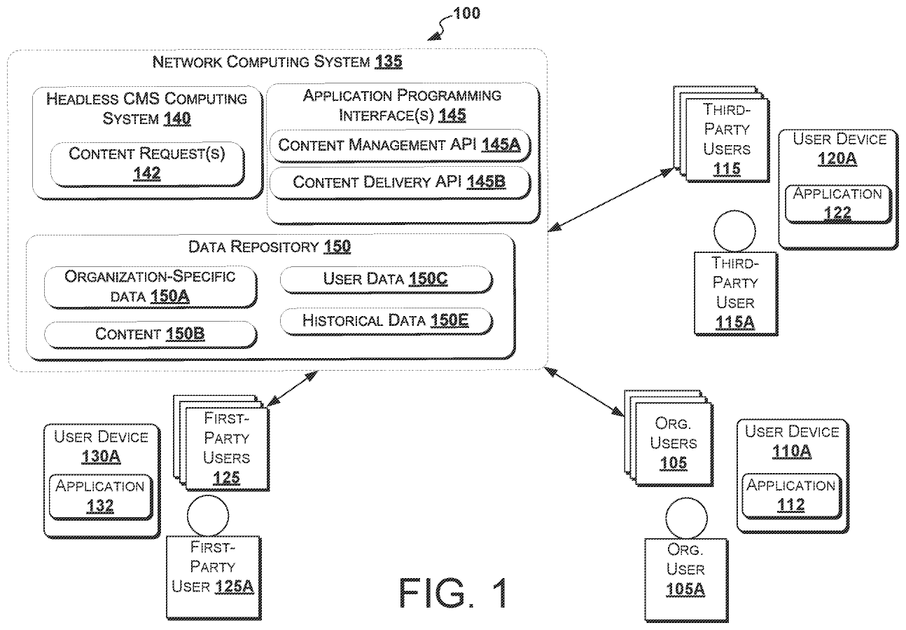

FIG. 1 depicts a block diagram of an example system 100 for presenting an iFrame modal in the parent window according to example embodiments of the present disclosure. As illustrated, FIG. 1 shows a computing system 100 that can include one or more organization users 105 (e.g., organization user 105A), one or more third-party users 115 (e.g., third-party user 115A), and one or more first-party users 125 (e.g., first-party user 125A).

Organization users 105 (e.g., organization user 105A) can be associated with one or more user devices (e.g., user device 110A). User device 110A can be any user device. For instance, user device 110A can be a computer, mobile device, tablet, or other devices. The user device 110A can include a software application 112 associated with a content management service entity, which can run on the user device 110A. As described herein software applications can include an application capable of accessing websites or web applications.

The computing system 100 can include one or more third-party users 115. The third-party users 115 can receive data indicative of content from organization users 105. For example, the third-party user 115A can submit a request through a user device 120A associated with the user (e.g., via a software application such as application 122).

The computing system 100 can include one or more first-party users 125. First-party users 125 can include first-party user 125A. First-party users 125 can be associated with one or more devices. For instance, first-party user 125A can be associated with user device 130A. The user device 130A can include a software application 132. First-party users 125 can be associated with a headless content management system (headless CMS) service entity (e.g., associated with headless CMS computing system 140). First-party users 125 can include, for example, system engineers, product liaisons, business users, product managers, or administrators associated with the headless CMS service entity.

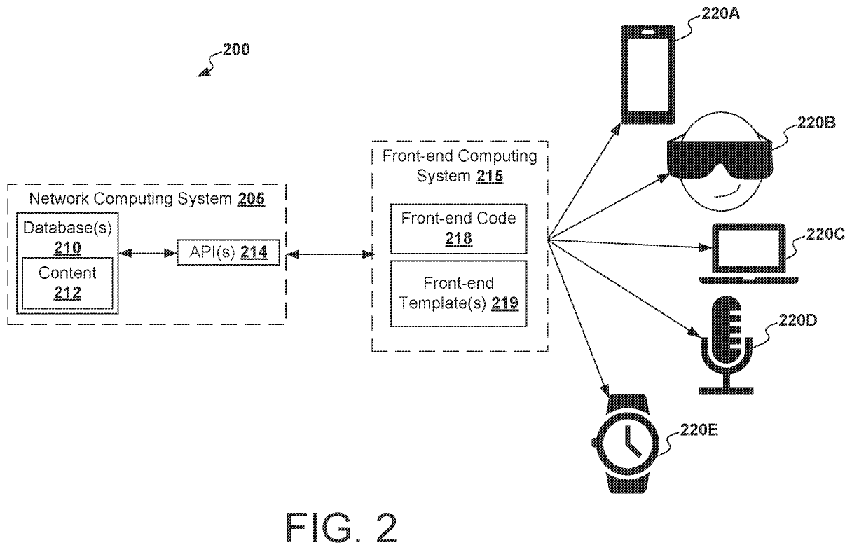

A headless content management system (headless CMS) can include a content management system configured to manage and organize content without a connected front-end or display later. For instance, a headless CMS can provide a platform to allow for creation, editing, and delivery of content to a plurality of front-end device interfaces. The headless CMS can allow for organization users 105 to generate or manage content item that can be stored in back-end servers (e.g., associated with network computing system 135) and provided for display to one or more third-party users 115 (e.g., third-party user 115A) via an interface of an associated user device (e.g., user device 120A). An example configuration for a headless CMS is described with regard to FIG. 2. In some implementations, content can include content associated with headless CMS computing system 140 (e.g., content associated with a parent window), or content associated with organization users 105 (e.g., content associated with an iFrame or modal).

A headless CMS can provide for benefits including omnichannel content delivery, rapid content deployment (via API), modular content and assets, and limitless integrations that power next-level digital experiences. The benefits can additionally include supporting an unlimited number of digital channels compared to traditional CMS that require multiple parallel content management system instances to provide content to more than one digital channel (e.g., web and mobile). The API approach can facilitate quickly scaling or deploying new content channels. The content can be managed and deployed across touchpoints without being duplicated or reformatted due to the modular nature of the content (e.g., not being dependent on any specific front-end display). Additionally, the content can connect to a plurality of services and software removing prior silos from systems like CRM, Artificial Intelligence/Machine Learning (AI/ML), personalization tools, or localization platforms.

A network computing system 135 can include a computing system associated with a service entity that can facilitate headless content management between organization users 105 and third-party users 115. Network computing system 135 can include headless CMS computing system 140, application programming interfaces 145, and data repository 150.

A headless CMS computing system 140 associated with the headless CMS service entity can facilitate the delivery of content from organization users 105 to third-party users 115 via associated user devices (e.g., user device 120A). The headless CMS computing system 140 can obtain data indicative of one or more feature utilization request(s) from organization users 105. The headless CMS computing system 140 can obtain data indicative of one or more content requests 142 from third-party users 115.

Headless CMS computing system 140 can interface with the one or more user devices (e.g., user device 110A, 120A, or 130A) associated with one or more users (e.g., organization users 105, third-party users 115, or first-party users 125) using one or more application programming interfaces 145. For instance, first-party user devices (e.g., user device 130A) can interface with headless CMS computing system 140 via application 132. For instance, organization user devices (e.g., user device 110A) can interface with headless CMS computing system 140 via content management API 145A. For instance, third-party user devices (e.g., user device 120A) can interface with headless CMS computing system 140 via content delivery API 145B.

First-party user 125 (e.g., first-party user 125A) can interact with headless CMS computing system 140 by providing input via an application 132 via user device 130A. For instance, first-party user 125A input can be used to update data repository 150.

Data repository 150 can include organization-specific data 150A, content 150B, user data 150C, historical data 150D, or any other relevant data (e.g., system-level data associated with a plurality of users, expected demand for particular features, expected demand for particular content, and the like). Organization-specific data 150A can include data indicative of user permissions of one or more users associated with a respective organization. For instance, user permissions can include features that are available to the user based on a designated role of the user. User roles can include owner, admin, developer, content manager, or custom role.

Content 150B can include one or more content items obtained from organization users 105. For instance, the organization user 105A can provide a plurality of content items (e.g., assets, images, documents, and the like) to the headless CMS computing system 140 via content management API 145A. The headless CMS computing system 140 can be used to design content that will be displayed to third-party users 115 from the organization users 105.

User data 150C can include data associated with first-party users 125, organization users 105, or third-party users 115. Historical data 150D can include data associated with organization users 105.

The network computing system 135 can include a plurality of potential system architecture designs. FIG. 2 depicts an example system architecture 200 associated with a headless CMS system for facilitating content management and delivery between organization users and third-party users. The architecture can include network computing system 205, front-end computing system 215, and one or more devices 220A-220E.

Network computing system 205 can include database(s) 210 which can include content 212. Content 212 can be content generated or provided by an organization (e.g., organization associated with organization users 105) and stored in database(s) 210. For instance, content can include media files, fields, structures, images, text, video, audio, iFrames, modals, and the like.

Network computing system 205 can include API(s) 214. API(s) 214 can interface with external computing systems. External computing systems can include front-end computing system 215. Front-end computing system 215 can be a web server or some means for interfacing with the one or more devices 220A-220E. Front-end computing system 215 can include front-end code 218 and front-end templates 219. Front-end code 218 and front-end templates 219 can be used by API(s) 214 to organize content 212 in a manner that can be rendered via a plurality of user devices (e.g., devices 220A-220E). For instance, Front-end template(s) can include a first template associated with providing display via a mobile device (e.g., device 220A), a second template associated with providing display via a virtual reality/augmented reality (VR/AR) device (e.g., device 220B), a third template associated with providing display via a web browser of a computing device (e.g., device 220C), a fourth template associated with providing display via an audio interface of a device (e.g., device 220D), or a fifth template associated with providing display via a wearable device (e.g., device 220E). Devices 220A-220E have been described as particular types of devices for illustrative purposes only and are not meant to limit the disclosure. Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

Organization users can include content providers that can interface with a network computing system associated with the headless CMS service entity to generate, modify, or provide content to be displayed (e.g., published) to end users. The headless CMS service entity can provide for an interface for content providers to interact with to generate and modify content items and can provide a computing system for facilitating serving (e.g., publishing) the content from the content provider to the end user in a format that improves user experience on both the content provider and end-user side.

Organization users can include developers that can interface with a network computing system associated with the headless CMS service entity to create applications, create integrations with IoT devices, develop applications and websites, modify applications and websites, and the like.

In some implementations, the headless CMS service entity can be associated with providing Software as a Service (SaaS) to organization users or other users. In some implementations users can include business users. The organizations can have one or more users associated with the content provider. The one or more users can have designated roles associated with permissions. The permissions can be associated with one or more keys (e.g., features) associated with the headless CMS service. For instance, keys can relate to an ability to adjust content items, add more users, perform API calls, and the like. Tokens can include access tokens, delivery tokens, management tokens, and authtokens. Tokens can be utilized to allow users with tokens to perform certain actions or access certain pages that a user without a token cannot access. For instance, tokens can be associated with the ability to rate limit, create stacks, adjust the number of users, adjust roles of users, and the like.

The present disclosure relates to the provisioning of iFrame modals within the parent window that allow for the front-end code 218 and front-end templates 219 to provide for visual display of iFrame modals that appear to a user to be outside of the iFrame, while maintaining security benefits of the modal remaining within the iFrame.

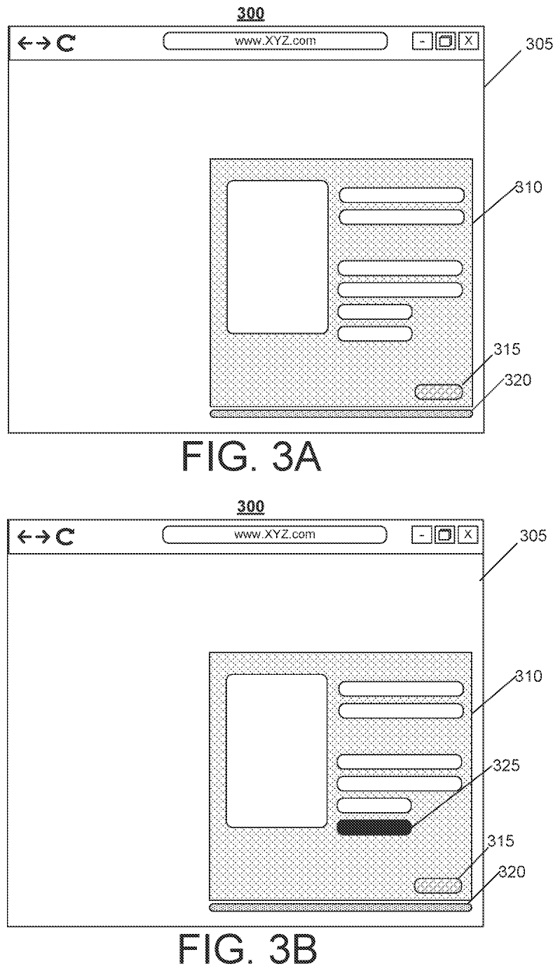

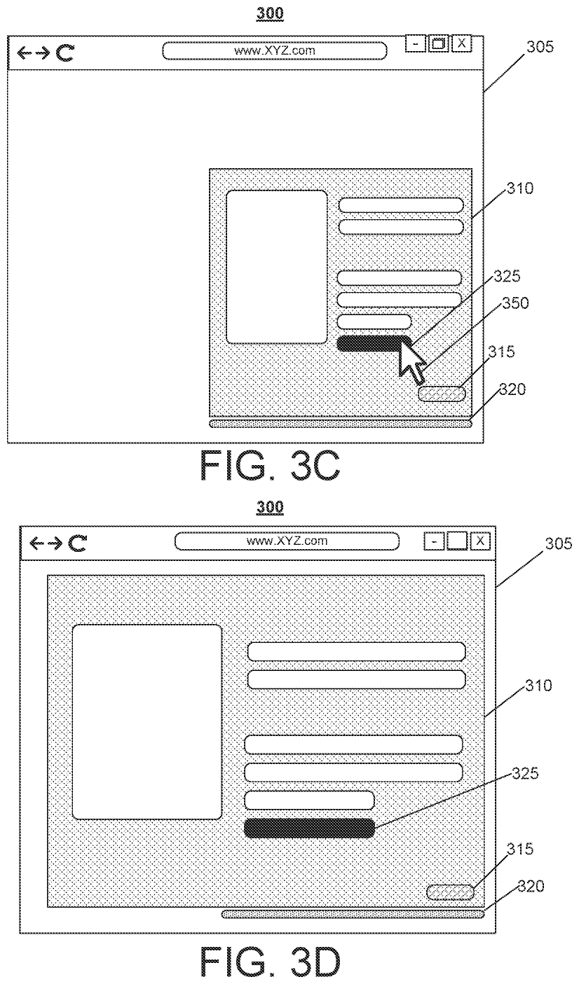

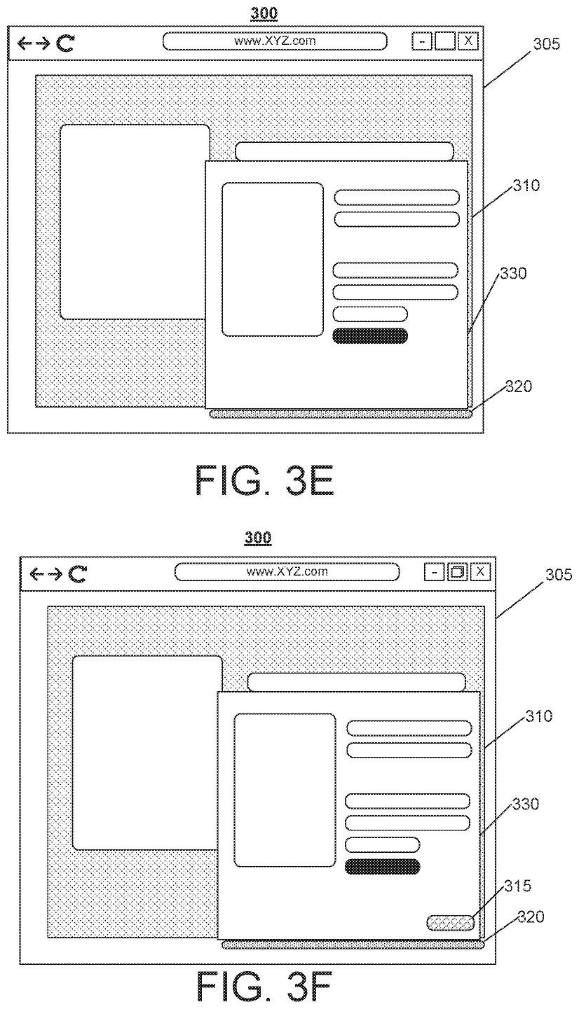

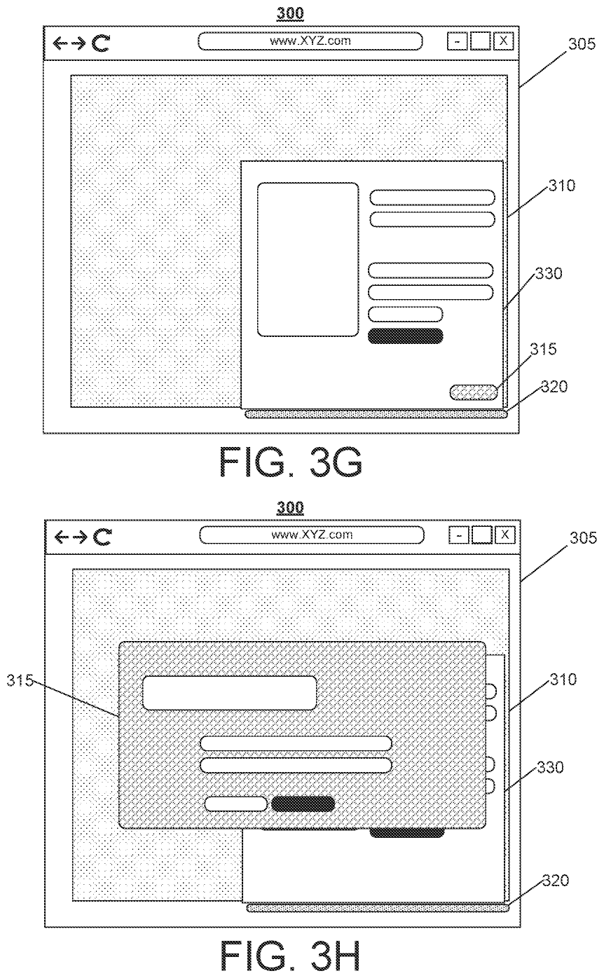

FIG. 3A-FIG. 3H depict example user interfaces according to example embodiments of the present disclosure. As described herein, the present disclosure can include a system presenting iFrame modal within the parent window. As depicted in FIG. 3A the user interface 300 can include a parent window 305, an iFrame 310, a modal component 315, and an imitation document object model (DOM) wrapper component 320.

As depicted in FIG. 3B, iFrame 310 of user interface 300 can include an interactive component 325 that a user can select to cause modal content (e.g., modal component 315) to be presented for display via user interface 300.

As depicted in FIG. 3C, a user can select the interactive component 325 using selection tool 350. The computing system can obtain data indicative of the user providing input indicative of selecting the interactive component 325.

As depicted in FIG. 3D, in response to obtaining the data indicative of the user providing input indicative of selecting the interactive component 325, the computing system can resize the iFrame 310. In some instances the iFrame 310 can be resized to be larger than the original iFrame size. In some instances, the iFrame 310 can be resized to be the same size as parent window 305.

As depicted in FIG. 3E, the computing system can generate and provide for display a second iFrame 330. The second iFrame 330 can be an imitation DOM wrapper (e.g., associated with imitation DOM wrapper component 320). The second iFrame 330 can be at the same level as iFrame 310. The second iFrame 330 can appear to be the initial iFrame 310 to a user (e.g., third-party user 115A) viewing user interface 300 via a user device (e.g., user device 120A).

As depicted in FIG. 3F, user interface 300 can include modal component 315.

As depicted in FIG. 3G, the computing system can update the opacity of iFrame 310 to zero. The iFrame 310 can appear to not be visible (e.g., to a user viewing user interface 300 via a user device). The contents of parent window 305 and second iFrame 330 can be visible.

As depicted in FIG. 3H, the computing system can enlarge modal component 315. For instance, modal component 315 will be provided for display within iFrame 310. However, it will appear as though modal component 315 has opened within parent window 305 and outside of iFrame 310. This illusion will be created by the opacity of iFrame 310 being set to zero and the contents of parent window 305 and second iFrame 330 being visible to a user viewing user interface 300.

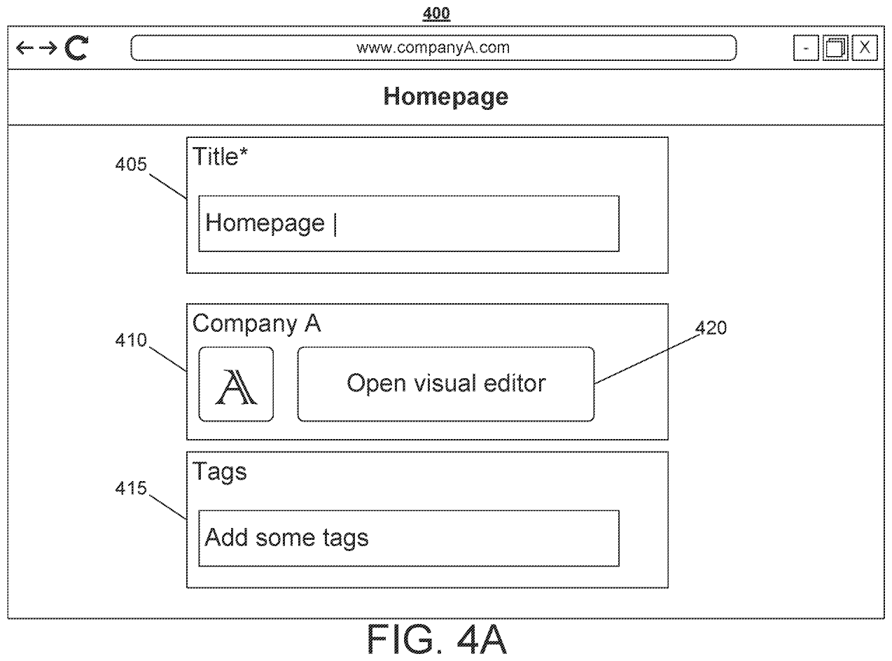

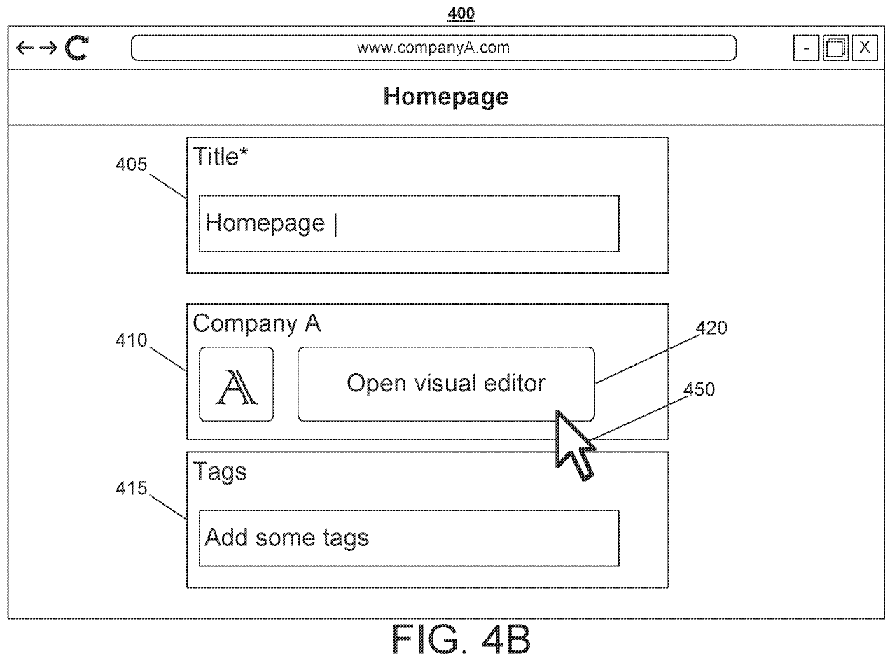

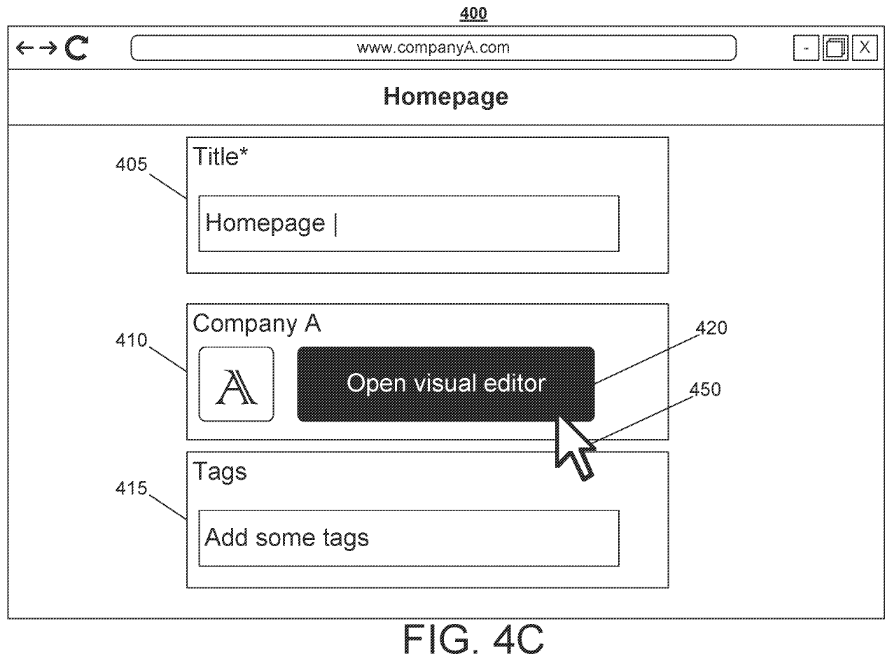

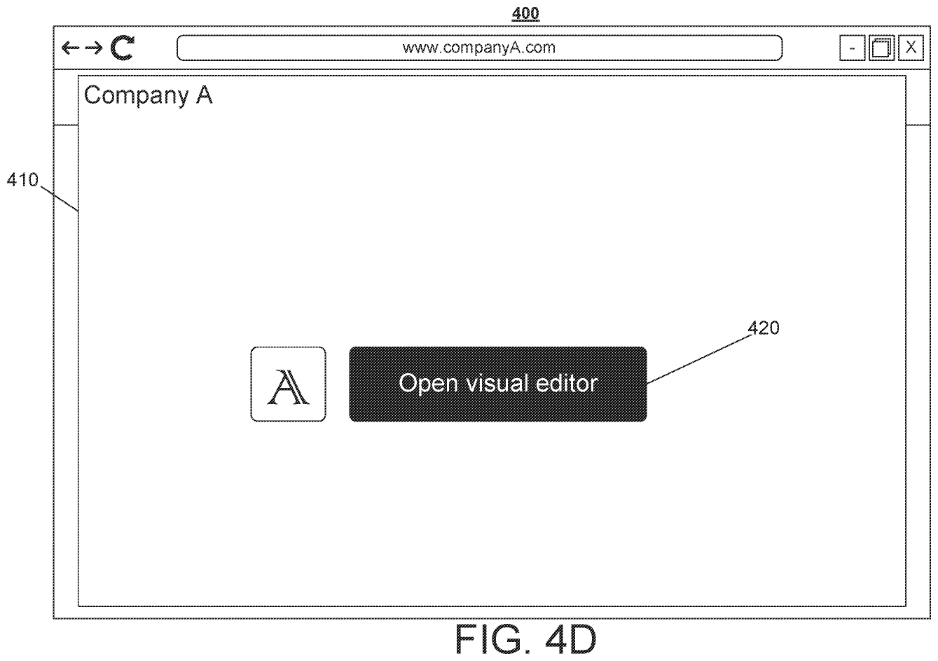

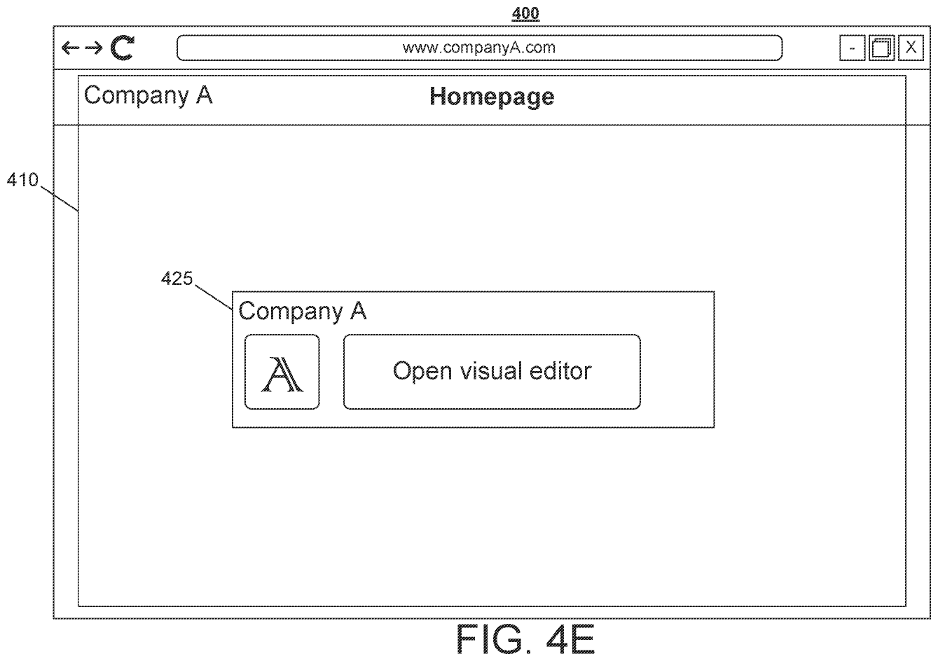

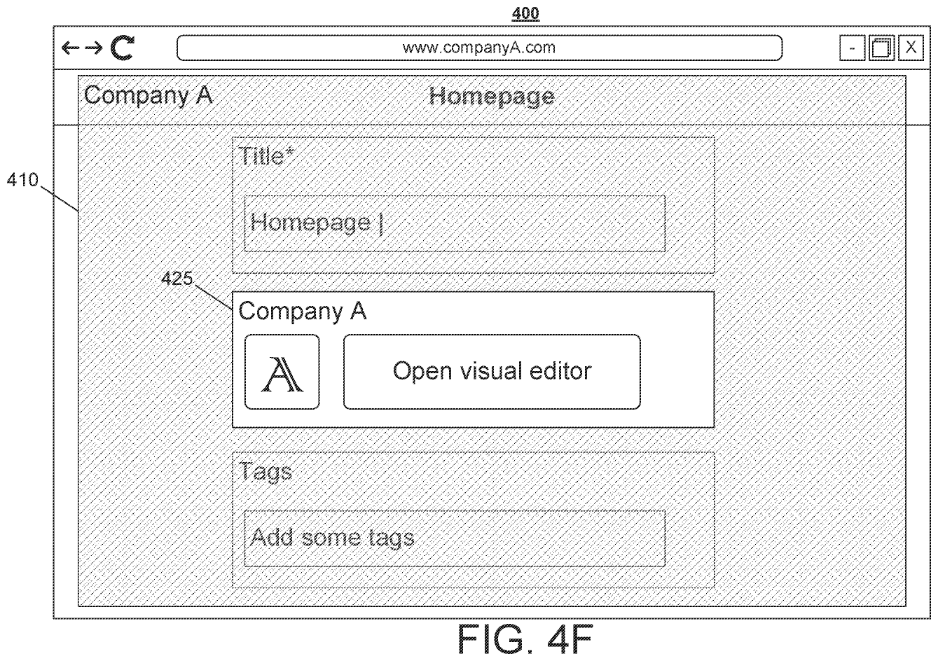

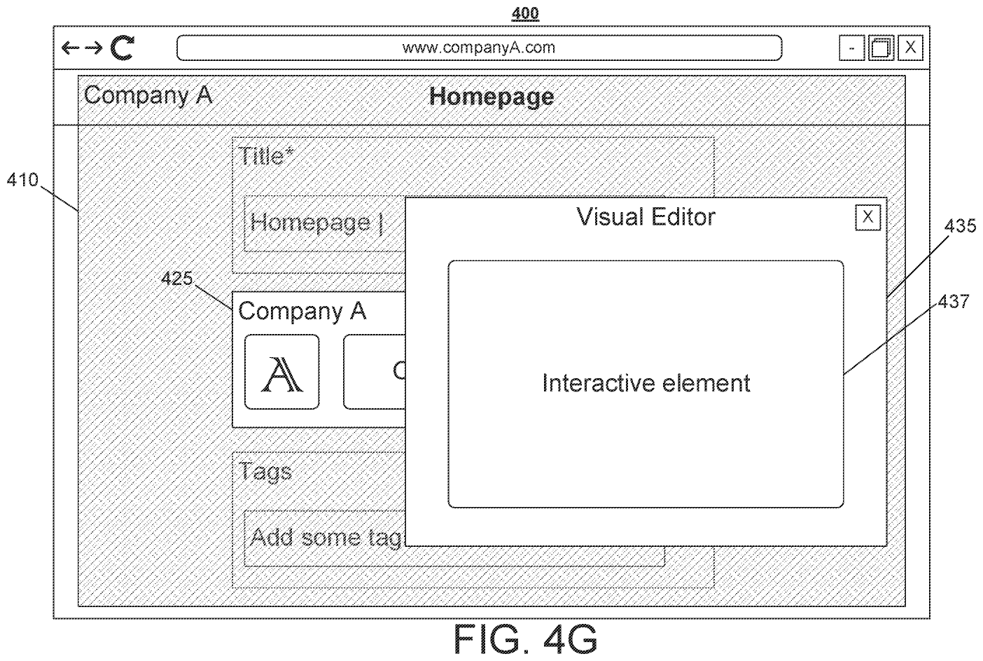

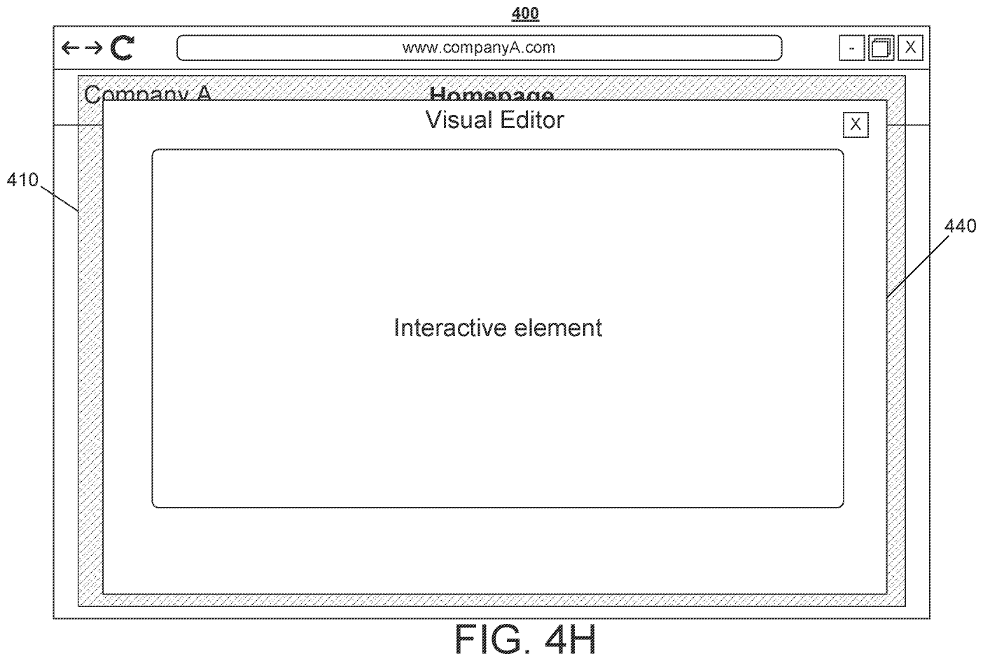

FIG. 4A-FIG. 4H depict an additional example user interface 400 according to example embodiments of the present disclosure. FIG. 4A depicts an example user interface 400. User interface 400 can include a first interactive user interface element 405, a second interactive user interface element 410, and a third interactive user interface element 415. A first interactive user interface element 405 can be associated with an input component for generating a title for a website. Second interactive user interface element 410 can include a modal component 420. The modal component 420 can be selected by a user to cause an interactive modal component to be displayed via user interface 400.

Traditional methods would limit the display of the interactive modal component to within the initial constraints of the associated iFrame (e.g., first interactive user interface element 405). Thus traditional methods could crop out essential elements of the modal component due to the size constraints of the iFrame. This can result in the inability to access or utilize certain features associated with the modal component.

As depicted in FIG. 4B, a user can provide input indicative of selection of an interactive user interface element (e.g., modal component 420) utilizing selection tool 450. As depicted in FIG. 4C, the computing system can obtain data indicative of a user selecting the modal component. In response, the computing system can perform action to update user interface 400 (e.g., as depicted in FIG. 4D-FIG. 4H).

As depicted in FIG. 4D, the computing system can resize the second interactive user interface element 410 (e.g., an iFrame) to be larger than the initial size of second interactive user interface element 410 (e.g., as depicted in FIG. 4A-FIG. 4C). The iFrame can include modal component 420.

As depicted in FIG. 4E, the computing system can generate a fourth interface element 425. The fourth interface element 425 can be an imitation document object model (DOM). The fourth interface element 425 can mimic second interactive user interface element 410 (e.g., to visually appear the same as the initial appearance of second interactive user interface element 410).

As depicted in FIG. 4F, the computing system can adjust the opacity of second interactive user interface element 410. For instance, the computing system can adjust the opacity of second interactive user interface element 410 to 0%, 5%, 10%, 50%, or any percent between 0% and 100%. 0% opacity can be associated with second interactive user interface element 410 being completely transparent (e.g., invisible) to a user viewing user interface 400. Fourth interface element 425 can be visible via user interface 400 (e.g., appearing as though the second interactive user interface element 410 is still being displayed via user interface 400).

As depicted in FIG. 4G, the computing system can cause the modal component 435 to be rendered via user interface 400. Modal component 435 can include one or more interactive elements. In some implementations, modal component 435 can be a chat box, chat bot, a visual editor, a messaging function, a static message, an interactive image, a prompt to complete an action, one or more input components (e.g., fields, selectable buttons), signing up for a newsletter, providing a preview, providing a warning, providing an alert, prompting a user to input information associated with a confirmation, providing a media display, prompting a user to interact with the modal for a multi-step process (e.g., setting up an account, setting initial settings for a website or application), or other similar functions. As described herein, a modal (e.g., modal window, lightbox) can be a webpage element that displays in front of and deactivates all other page content. To return to the main content (e.g., exit the modal), a user must provide input indicative of an interaction with the modal or close the modal (e.g., selecting a close button, hitting escape). A modal can be utilized to display important information or draw attention to an important action. For instance, as depicted in FIG. 4G, the modal component 435 can be a visual editor including an interactive element 437.

In some implementations, the modal component 435 can be displayed in a portion of the parent window that provides for other web page elements to be visible. For instance, the fourth interface element 425 can be visible to a user viewing user interface 400.

In some implementations, e.g., as depicted in FIG. 4H, the modal component 440 can be displayed in a portion of the parent window that prevents the display of most (or all) of the other content previously visible via user interface 400.

The computing system can obtain data indicative of the user interacting with the modal component. Upon receipt of the data indicative of the user interaction, the computing system can close the modal, remove the fourth interface element, and return the second user interface component to its initial state. For instance, the second user interface (e.g., iFrame), can be resized to its initial dimensions and the opacity of the second user interface (e.g., iFrame) can be returned to the initial state (e.g., opacity of 100%, completely visible).

As described herein, the user interface element can be an iFrame. An iFrame can be a HTML element that loads another HTML page within a parent window (e.g., populates a second website within the parent window). In some instances, the iFrame and parent window can be associated with distinct domains. iFrames can have varying dimensional constraints. In some implementations, an iFrame can have a dimension of zero pixels. In some instances an iFrame with dimension of zero pixels can cause a modal component associated with the iFrame to not be displayed at all. Thus, for the modal component to be visible, the associated iFrame would need to be resized.

iFrames can provide benefits such as improved security. For instance, an iFrame can restrict how a document or script can be loaded by an origin. For instance, the iFrame can prevent the content within an iFrame from being embedded within a parent window. Utilizing an iFrame with a different domain can trigger cross-domain policies. For instance, the cross-domain policies can provide for separation between the code associated with the parent website and the content of the iFrame. Thus, by utilizing the iFrame, the computing system can prevent access to DOM, cookies, or local storage associated with the parent window.

The present disclosure allows for benefitting from the security enhancement associated with iFrames, while also optimizing the utilization of available user interface display space. Thus, the present disclosure provides for improvements by allowing for increased display of information via a user interface while providing for enhanced security.

In some implementations, the modal window can be larger than the first size constraint associated with the iFrame. For instance, the first size constraint can be associated with a height and width (e.g., pixels, inches, centimeters).

In some implementations, the modal window can include one or more interactive features that would be cropped and excluded if limited to an initial display size equal to the first size constraint associated with the iFrame.

In some implementations, the iFrame size can be increased to 100% of the size of the parent window. In some implementations the iFrame size can be increased to an amount that is greater than the first constraint associated with the iFrame and smaller than 100% of the size of the parent window.

In some implementations the imitation DOM (e.g., fourth interface element, copy of the first iFrame) can appear to the user as the original iFrame.

While the figures depict the interfaces in steps that are visible, the present disclosure can operate such that the modal component would appear nearly instantaneously after a user selection of the initial modal component. For instance, a user could select a button associated with the modal component and the modal component would appear on the screen in less than one second. For example, a user would be unaware of the additional steps taking place (e.g., resizing the iFrame, adjusting the opacity to zero, generating the imitation DOM, causing the modal component to be provided for display) to generate this seamless user experience. By way of example, the method described herein can be performed in real time or near real time.

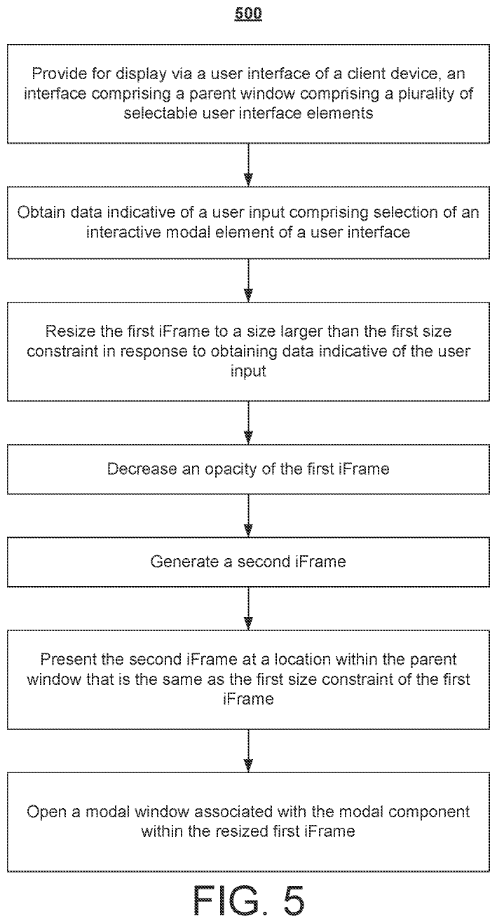

FIG. 5 depicts a flow chart diagram of an example method for presenting an inline frame modal in the parent window according to example embodiments of the present disclosure. Although FIG. 5 depicts steps performed in a particular order for purposes of illustration and discussion, the methods of the present disclosure are not limited to the particularly illustrated order or arrangement. The various steps of method 500 can be omitted, rearranged, combined, or adapted in various ways without deviating from the scope of the present disclosure.

At (502), method 500 can include providing for display via a user interface of a client device, an interface comprising a parent window comprising a plurality of selectable user interface elements. For instance, a computing system can provide for display via a user interface of a client device, an interface comprising a parent window comprising a plurality of selectable user interface elements. The plurality of selectable user interface elements comprises at least a first iFrame including a modal component. The first iFrame has a first size constraint. As described herein, the first iFrame restricts content associated with the modal from being embedded within the parent window. In some implementations, the modal component can be associated with a third-party not associated with the parent window. In some implementations, the first size constraint can be associated with a length, width, and guide point. The guide point can be a corner point of the first size constraint used to determine a location within the user interface to display content associated with the first size constraint.

At (504), method 500 can include obtaining data indicative of a user input comprising selection of an interactive modal element of a user interface. For instance, the computing system can obtain data indicative of a user input comprising selection of an interactive modal element of a user interface.

At (506), method 500 can include, in response to obtaining data indicative of the user input, resizing the first iFrame to a size larger than the first size constraint. For instance, the computing system can, in response to obtaining data indicative of the user input, resize the first iFrame to a size larger than the first size constraint. As described herein, resizing the first iFrame can include resizing the first iFrame to be a size in between the size of the first size constraint and a size constraint associated with the parent window. In some implementations, resizing the first iFrame can include resizing the first iFrame to be a size that is equal to a size constraint associated with the parent window.

At (508), method 500 can include decreasing an opacity of the first iFrame. For instance, the computing system can decrease an opacity of the first iFrame. In some implementations decreasing the opacity of the first iFrame can include decreasing the opacity of the first iFrame to 0%.

At (510), method 500 can include generating a second iFrame. For instance, the computing system can generate a second iFrame. The second iFrame is an imitation DOM that is a duplicate of the first iFrame.

At (512), method 500 can include presenting the second iFrame at a location within the parent window that is the same as the first size constraint of the first iFrame. For instance, the computing system can present the second iFrame at a location within the parent window that is the same as the first size constraint of the first iFrame.

At (514), method 500 can include opening a modal window associated with the modal component within the resized first iFrame. For instance, the computing system can open a modal window associated with the modal component within the resized first iFrame. The modal window appears to be opened within the parent window and outside the first iFrame. As described herein, the one or more interactive components associated with the modal window can be fully visible within the resized first iFrame. In some implementations, the modal component can include at least one of: a chat box, a chat bot, a visual editor, a messaging function, an interactive image, a prompt to complete an action, one or more input components, or a prompt to complete an action.

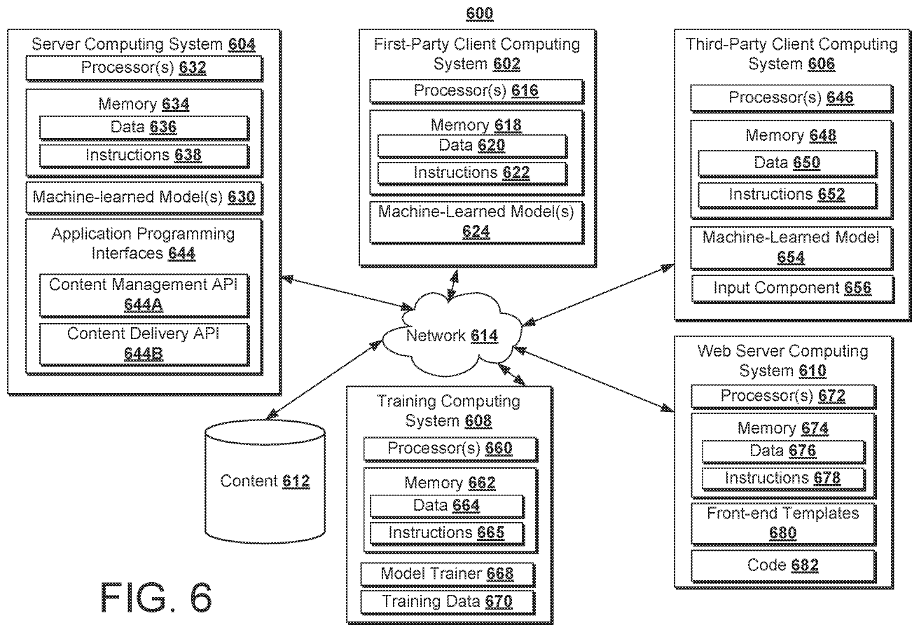

FIG. 6 depicts a block diagram of an example computing system 600 that allocates system resources using dual-limit account provisioning according to example embodiments of the present disclosure. The computing system 600 includes a first-party client computing system 602, a server computing system 604, an third-party client computing system 606, a training computing system 608, a web server computing system 610, and content database 612 that are communicatively coupled over a network 614.

The first-party client computing system 602 can include one or more computing devices. Computing devices can include any type of computing device, such as, for example, a personal computing device (e.g., laptop or desktop), a mobile computing device (e.g., smartphone or tablet), a wearable computing device, an embedded computing device, or any other type of computing device.

The one or more devices associated with first-party client computing system 602 include one or more processors 616 and a memory 618. The one or more processors 616 can be any suitable processing device (e.g., a processor core, a microprocessor, an ASIC, an FPGA, a controller, a microcontroller, etc.) and can be one processor or a plurality of processors that are operatively connected. The memory 618 can include one or more computer-readable storage media which may be non-transitory, such as RAM, ROM, EEPROM, EPROM, flash memory devices, magnetic disks, etc., and combinations thereof. The memory 618 can store data 620 and instructions 622 which are executed by the processor 616 to cause the first-party client computing system 602 to perform operations.

In some implementations, the first-party client computing system 602 can store or include one or more machine-learned models 624. For example, the machine-learned models 624 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models.

In some implementations, the one or more machine-learned models 624 can be received from the server computing system 604 over network 614, stored in the user computing device memory 618, and then used or otherwise implemented by the one or more processors 646. In some implementations, the first-party client computing system 602 can implement multiple parallel instances of a single machine-learned model.

More particularly, the machine learned model can obtain data indicative of user input. The user data can be associated with a current user session or include historical user data (e.g., historical data 150D). For example, data associated with a current user session can be data obtained in real-time via an input component.

Historical user data can include data associated with a user account, user characteristics, etc. Historical user data can include data associated with a user device (e.g., device identifier). In addition, or alternatively, historical user data can include data associated with a user identifier. In some embodiments, historical user data can include aggregate data associated with a plurality of user identifiers. In some embodiments, the training data 670 can include session data (e.g., of one or more input sessions) associated with one or more input devices, such as session data indexed over a type of input interface or device (e.g., mobile device with touchscreen, mobile device with keyboard, large touchscreen, small touchscreen, large touchscreen, voice inputs, or combinations thereof, etc.). In some embodiments, the training data 670 can include session data not associated with user identifiers.

Additionally, or alternatively, one or more machine-learned models 624 can be included in or otherwise stored and implemented by the server computing system 604 that communicates with the first-party client computing system 602 according to a client-server relationship. For example, the machine-learned models 624 can be implemented by the server computing system 604 as a portion of a web service (e.g., a content development service). Thus, one or more models 624 can be stored and implemented at the first-party client computing system 602 or one or more models 624 can be stored and implemented at the server computing system 604.

The first-party client computing system 602 can also include one or more user input components that can receive user input. For example, the user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 604 includes one or more processors 632 and a memory 634. The one or more processors 632 can be any suitable processing device (e.g., a processor core, a microprocessor, an ASIC, an FPGA, a controller, a microcontroller, etc.) and can be one processor or a plurality of processors that are operatively connected. The memory 634 can include one or more computer-readable storage media which may be non-transitory, such as RAM, ROM, EEPROM, EPROM, flash memory devices, magnetic disks, etc., and combinations thereof. The memory 634 can store data 636 and instructions 638 which are executed by the processor 632 to cause the server computing system 604 to perform operations.

In some implementations, the server computing system 604 includes or is otherwise implemented by one or more server computing devices. In instances in which the server computing system 604 includes plural server computing devices, such server computing devices can operate according to sequential computing architectures, parallel computing architectures, or some combination thereof.

The server computing system 604 can include one or more APIs. APIs can include content management API 644A, or content delivery API 644B.

Server computing system 604 can interface with the one or more user devices (e.g., user devices associated with first-party client computing system 602, third-party client computing system 606, or web server computing system 610) associated with one or more users (e.g., organization users 105, third-party users 115, or first-party users 125) using one or more application programming interfaces 644. For instance, organization user devices (e.g., user device associated with third-party client computing system 606) can interface with server computing system 604 via content management API 644A. For instance, third-party user devices (e.g., user device associated with web server computing system 610) can interface with server computing system 604 via content delivery API 644B.

As described above, the server computing system 604 can store or otherwise include one or more machine-learned models 630. For example, the models 630 can be or can otherwise include various machine-learned models.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 630 are discussed herein.

The first-party client computing system 602, third-party client computing system 606, or the server computing system 604 can train the models 624, 630, or 654 via interaction with the training computing system 608 that is communicatively coupled over the network 614. The training computing system 608 can be separate from the server computing system 604 or can be a portion of the server computing system 604.

The third-party client computing system 606 can include one or more computing devices. Computing devices can include any type of computing device, such as, for example, a personal computing device (e.g., laptop or desktop), a mobile computing device (e.g., smartphone or tablet), a wearable computing device, an embedded computing device, or any other type of computing device. Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

The one or more devices associated with third-party client computing system 606 include one or more processors 646 and a memory 648. The one or more processors 646 can be any suitable processing device (e.g., a processor core, a microprocessor, an ASIC, an FPGA, a controller, a microcontroller, etc.) and can be one processor or a plurality of processors that are operatively connected. The memory 648 can include one or more computer-readable storage media which may be non-transitory, such as RAM, ROM, EEPROM, EPROM, flash memory devices, magnetic disks, etc., and combinations thereof. The memory 648 can store data 650 and instructions 652 which are executed by the processor 646 to cause the third-party client computing system 606 to perform operations.

In some implementations, the third-party client computing system 606 can store or include one or more machine-learned models 654. For example, the machine-learned models 654 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 654 are discussed herein.

In some implementations, the one or more machine-learned models 654 can be received from the server computing system 604 over network 614, memory 648 (e.g., stored in a user computing device memory associated with third-party client computing system 606), and then used or otherwise implemented by the one or more processors 646. In some implementations, the third-party client computing system 606 can implement multiple parallel instances of a single machine-learned model 654.

More particularly, the machine learned model can obtain data indicative of user input. The user input data can be associated with a current user session or include historical user data. For example, data associated with a current user session can be data obtained in real-time via an input component 656. User data can include user session data, user context data, and user account data.

The third-party client computing system 606 can include user data. User data can include user session data, user context data, or user account data. User session data can include data obtained via input component 656 indicative of a current user session. For example, user session data can include a request for access to a particular feature, or data indicative of a utilization amount of a particular feature received within a threshold time of the current session. For example, a user can submit a first request and five minutes later submit a second request. The proximity of the first request and second request in time can be context data.

In some implementations, user data can be used as input for one or more machine-learned models 624, 630, or 654. User data can include data associated with a user account, user characteristics, and the like. User data can include data associated with a user device (e.g., device identifier). In addition, or alternatively, user data can include data associated with a user identifier. In some embodiments, user data can include aggregate data associated with a plurality of user identifiers (e.g., a group of users associated with an organization). In some embodiments, the user session data can include data indicative of one or more input sessions associated with an input component 656 of a device. In some embodiments, data in a database associated with user data can be used as training data 670.

Additionally, or alternatively, one or more machine-learned models 654 can be included in or otherwise stored and implemented by the server computing system 604 that communicates with the third-party client computing system 606 according to a client-server relationship. For example, the machine-learned models 654 can be implemented by the server computing system 604 as a portion of a web service (e.g., a content development service, a campaign management service, a content strategy management service). Thus, one or more models 654 can be stored and implemented at the third-party client computing system 606 or one or more models 654 can be stored and implemented at the server computing system 604.

The training computing system 608 includes one or more processors 660 and a memory 662. The one or more processors 660 can be any suitable processing device (e.g., a processor core, a microprocessor, an ASIC, an FPGA, a controller, a microcontroller, etc.) and can be one processor or a plurality of processors that are operatively connected. The memory 662 can include one or more computer-readable storage media which may be non-transitory, such as RAM, ROM, EEPROM, EPROM, flash memory devices, magnetic disks, etc., and combinations thereof. The memory 662 can store data 664 and instructions 665 which are executed by the processor 660 to cause the training computing system 608 to perform operations. In some implementations, the training computing system 608 includes or is otherwise implemented by one or more server computing devices associated with server computing system 604.

The training computing system 608 can include a model trainer 668 that trains the machine-learned models 624, 630, or 654 stored at the first-party client computing system 602, third-party client computing system 606, or the server computing system 604 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 668 can perform a number of generalization techniques (e.g., weight decays, dropouts, etc.) to improve the generalization capability of the models being trained.

In particular, the model trainer 668 can train the machine-learned models 624, 630, or 654 based on a set of training data 670. The training data 670 can include, for example, user feature utilization data or user session data.

In some embodiments, the machine-learned models 624, 630, or 654 can be trained using reinforcement learning. The computing system can learn appropriate weights based on receiving a reward for output that results in positive feedback. The training data 670 and user data (e.g., user session data, user context data, or user account data) can be used by a model trainer 668 to train any of machine-learned models 624, 630, or 654.

In some implementations, the computing system can train one or more machine-learned models of the machine-learned models 624, 630, or 654 through the use of one or more model trainers and training data. The model trainer(s) can train any one of the model(s) using one or more training or learning algorithms. One example training technique is backwards propagation of errors. In some implementations, the model trainer(s) can perform supervised training techniques using labeled training data. In other implementations, the model trainer(s) can perform unsupervised training techniques using unlabeled training data. In some implementations, the training data can include simulated training data (e.g., training data obtained from simulated scenarios, inputs, configurations, environments). In some implementations, the computing system can implement simulations for obtaining the training data or for implementing the model trainer(s) for training or testing the model(s). By way of example, the model trainer(s) can train one or more components of a machine-learned model to generate recommended limits using unsupervised training techniques using an objective function (e.g., costs, rewards, heuristics, constraints, etc.). In some implementations, the model trainer(s) can perform a number of generalization techniques to improve the generalization capability of the model(s) being trained. Generalization techniques include weight decay, dropouts, or other techniques.

In some implementations, if the user has provided consent, the training examples can be provided by the third-party client computing system 606. Thus, in such implementations, the model 654 provided to the third-party client computing system 606 can be trained by the training computing system 608 on user-specific data received from the third-party client computing system 606. In some instances, this process can be referred to as personalizing the model.

The model trainer 668 includes computer logic utilized to provide desired functionality. The model trainer 668 can be implemented in hardware, firmware, or software controlling a general-purpose processor. For example, in some implementations, the model trainer 668 includes program files stored on a storage device, loaded into a memory and executed by one or more processors. In other implementations, the model trainer 668 includes one or more sets of computer-executable instructions that are stored in a tangible computer-readable storage medium such as RAM, hard disk, or optical or magnetic media.

The network 614 can be any type of communications network, such as a local area network (e.g., intranet), wide area network (e.g., Internet), or some combination thereof and can include any number of wired or wireless links. In general, communication over the network 614 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the machine-learned models can be deployed on-device. For example, one or more components of a predictive machine-learned model or pipeline can be deployed on-device to avoid the upload of potentially sensitive information relating to the types of input, the types of device(s), or the contents of the inputs (e.g., relating to disabilities, contact information, address, etc.) to a server. For example, the server computing system can send a form with a learned context vector describing one or more input fields associated with a component (e.g., portion of an application associated with performance of a processing task). An onboard client model associated with the first-party client computing system 602 or third-party client computing system 606 can input local client characteristics (e.g., obtained via the user input component 656) and a context vector to generate a composed modular application. This on device processing can increase data privacy for a user. In some embodiments, this can also reduce the amount of data transmitted off-device, thereby reducing bandwidth usage.

The web server computing system 610 can include one or more computing devices. Computing devices can include any type of computing device, such as, for example, a personal computing device (e.g., laptop or desktop), a mobile computing device (e.g., smartphone or tablet), a wearable computing device, an embedded computing device, or any other type of computing device. Computing devices associated with web server computing system 610 can be third-party devices associated with end users or consumers of the content generated, managed, and published by a headless content management system (e.g., associated with server computing system 604). Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

The one or more devices associated with web server computing system 610 include one or more processors 672 and a memory 674. The one or more processors 672 can be any suitable processing device (e.g., a processor core, a microprocessor, an ASIC, an FPGA, a controller, a microcontroller, etc.) and can be one processor or a plurality of processors that are operatively connected. The memory 674 can include one or more computer-readable storage media which may be non-transitory, such as RAM, ROM, EEPROM, EPROM, flash memory devices, magnetic disks, etc., and combinations thereof. The memory 674 can store data 676 and instructions 678 which are executed by the processor 672 to cause the web server computing system 610 to perform operations.

The operations can include executing one or more front-end templates 680 or code 682 to provide content items to devices associated with end users (e.g., consumers). The content items can be generated by obtaining content from content database 612 (e.g., associated with server computing system) over network 614. For instance, the front-end template 680 and code 682 can be utilized to provide for display parent windows, iFrames, or modal components to end users (e.g., via third-party client computing system 606).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skills in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. Also, terms such as “based on” should be understood as “based at least in part on”.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

What is claimed is:

1. A computing system comprising:
one or more processors; and
one or more non-transitory computer-readable media storing instructions that are executable to cause the one or more processors to perform operations, the operations comprising:
providing for display via a user interface of a client device, an interface comprising a parent window comprising a plurality of selectable user interface elements, wherein the plurality of selectable user interface elements comprises at least a first iFrame including a modal component, wherein the first iFrame has a first size constraint;
obtaining data indicative of a user input comprising selection of an interactive modal element of a user interface;
in response to obtaining data indicative of the user input, resizing the first iFrame to a size larger than the first size constraint;
decreasing an opacity of the first iFrame;
generating a second iFrame, wherein the second iFrame is an imitation DOM that is a duplicate of the first iFrame;
presenting the second iFrame at a location within the parent window that is the same as the first size constraint of the first iFrame; and
opening a modal window associated with the modal component within the resized first iFrame, wherein the modal window appears to be opened within the parent window and outside the first iFrame.

2. The computing system of claim 1, wherein the first iFrame restricts content associated with the modal from being embedded within the parent window.

3. The computing system of claim 1, wherein the modal component is associated with a third-party not associated with the parent window.

4. The computing system of claim 1, wherein resizing the first iFrame comprises resizing the first iFrame to be a size in between the size of the first size constraint and a size constraint associated with the parent window.

5. The computing system of claim 1, wherein resizing the first iFrame comprises resizing the first iFrame to be a size that is equal to a size constraint associated with the parent window.

6. The computing system of claim 1, wherein one or more interactive components associated with the modal window are fully visible within the resized first iFrame.

7. The computing system of claim 1, wherein the modal component comprises at least one of: a chat box, a chat bot, a visual editor, a messaging function, an interactive image, a prompt to complete an action, one or more input components, or a prompt to complete an action.

8. The computing system of claim 1, wherein the first size constraint is associated with a length, width, and guide point.

9. The computing system of claim 8, wherein the guide point is a corner point of the first size constraint used to determine a location within the user interface to display content associated with the first size constraint.

10. The computing system of claim 1, wherein decreasing the opacity of the first iFrame comprises decreasing the opacity of the first iFrame to 0%.

11. A computer-implemented method, comprising:
providing for display via a user interface of a client device, an interface comprising a parent window comprising a plurality of selectable user interface elements, wherein the plurality of selectable user interface elements comprises at least a first iFrame including a modal component, wherein the first iFrame has a first size constraint;
obtaining data indicative of a user input comprising selection of an interactive modal element of a user interface;
in response to obtaining data indicative of the user input, resizing the first iFrame to a size larger than the first size constraint;
decreasing an opacity of the first iFrame;
generating a second iFrame, wherein the second iFrame is an imitation DOM that is a duplicate of the first iFrame;
presenting the second iFrame at a location within the parent window that is the same as the first size constraint of the first iFrame; and
opening a modal window associated with the modal component within the resized first iFrame, wherein the modal window appears to be opened within the parent window and outside the first iFrame.

12. The computer-implemented method of claim 11, wherein the iFrame restricts content associated with the modal from being embedded within the parent window.

13. The computer-implemented method of claim 11, wherein the modal component is associated with a third-party not associated with the parent window.

14. The computer-implemented method of claim 11, wherein resizing the first iFrame comprises resizing the first iFrame to be a size in between the size of the first size constraint and a size constraint associated with the parent window.

15. The computer-implemented method of claim 11, wherein resizing the first iFrame comprises resizing the first iFrame to be a size that is equal to a size constraint associated with the parent window.

16. The computer-implemented method of claim 11, wherein one or more interactive components associated with the modal window are fully visible within the resized first iFrame.

17. The computer-implemented method of claim 11, wherein the modal component comprises at least one of: a chat box, a chat bot, a visual editor, a messaging function, an interactive image, a prompt to complete an action, one or more input components, or a prompt to complete an action.

18. The computer-implemented method of claim 11, wherein the first size constraint is associated with a length, width, and guide point.

19. The computer-implemented method of claim 18, wherein the guide point is a corner point of the first size constraint used to determine a location within the user interface to display content associated with the first size constraint.

20. One or more non transitory computer readable media storing instructions that are executable by one or more processors to perform operations comprising:
providing for display via a user interface of a client device, an interface comprising a parent window comprising a plurality of selectable user interface elements, wherein the plurality of selectable user interface elements comprises at least a first iFrame including a modal component, wherein the first iFrame has a first size constraint;
obtaining data indicative of a user input comprising selection of an interactive modal element of a user interface;
in response to obtaining data indicative of the user input, resizing the first iFrame to a size larger than the first size constraint;
decreasing an opacity of the first iFrame;
generating a second iFrame, wherein the second iFrame is an imitation DOM that is a duplicate of the first iFrame;
presenting the second iFrame at a location within the parent window that is the same as the first size constraint of the first iFrame; and
opening a modal window associated with the modal component within the resized first iFrame, wherein the modal window appears to be opened within the parent window and outside the first iFrame.
